(19) United States
(12) Patent Application Publication
(10) Pub. No.: US 2017/0336048 A1
(43) Pub. Date: Nov. 23, 2017

(54) FLUORESCENT DIFFUSION BOARD FOR LIGHTING

(71) Applicant: GLLEPE CO., LTD., Daegu (KR)

(72) Inventor: Hee Jun KIM, Gumi-si (KR)

(73) Assignee: GLLEPE CO., LTD., Daegu (KR)

(21) Appl. No.: 15/599,961

(22) Filed: May 19, 2017

(30) Foreign Application Priority Data
May 23, 2016 (KR) 10-2016-0062639

(51) Int. Cl. F21V 3/04; G01N 21/25; F21Y 103/00

(52) U.S. Cl. CPC F21V 3/0427; G01N 21/25; F21V 3/0463; F21Y 2103/00

(57) ABSTRACT

Disclosed is a fluorescent diffusion board for lighting including a first layer containing an inorganic material and a polycarbonate resin and a second layer formed on one surface of the first layer and configured to contain a polycarbonate resin and a fluorescent material.

### BACKGROUND OF THE INVENTION

### 1. Technical Field

The present invention relates to a fluorescent diffusion board for lighting. More particularly, the present invention relates to a lighting board containing a fluorescent material, which may be easily utilized in a variety of applications ranging from small-area lighting to large-area lighting, and enables more uniform diffusion of light suitable for lighting.

### 2. Description of the Related Art

Useful as an advertising board, a polyvinyl chloride (PVC) laminated sheet is easily handled and is employed in a variety of applications and is thus widely utilized not only for small-sized boards but also for large-sized boards. Such a laminated sheet is easily mounted, is simple and flexible, and is not easily damaged, and thus the demand therefor is high. Furthermore, it has high flexibility and may be formed in a gel state, and. Thus, it may be advantageously easy to perform a processing such as calendar processing, etc.

Meanwhile, outdoor advertising boards exposed to the outdoors are manufactured using neon signs using glass tubes or acrylic sheets using a plurality of fluorescent lamps for light distribution, but require high power and voltage and thus suffer from low safety, difficulty of construction, high maintenance costs and a short lifetime, undesirably negating economic benefits.

Furthermore, acrylic sheets using a plurality of fluorescent lamps for light distribution may injure the appearance of buildings because the advertising board is thick due to a large number of fluorescent lamps and complex electric wiring.

Recently, a light source using a light-emitting diode (LED) has a long lifetime and a fast response rate, may be provided in various shapes, and may exhibit very high energy efficiency, and may thus be diversely utilized in a variety of fields, compared to typical light bulbs.

However, the light source using an LED is a point light source or the like, and the light diffusion capability thereof is insufficient for general lighting. Hence, in order for the light source such as an LED to serve for lighting, the light source such as a point light source or the like has to be more uniformly converted into a surface light source that is then diffused. Accordingly, research is needed for a diffusion board for lighting that is able to convert and diffuse a light source such as a point light source or the like into a surface light source more uniformly.

### CITATION LIST

### Patent Literature

(Patent Document 1) Korean Patent No. 10-0981960B1 (Sep. 7, 2010)

### SUMMARY OF THE INVENTION

Accordingly, the present invention has been made keeping in mind the problems encountered in the related art, and the purpose of the present invention relates to providing a fluorescent diffusion board for lighting, which enables a light source such as a point light source or the like to be more uniformly converted and diffused into a surface light source.

An embodiment of the present invention provides a fluorescent diffusion board for lighting, comprising a first layer including an inorganic material and a polycarbonate resin, and a second layer laminated on one surface of the first layer and configured to include a polycarbonate resin and a fluorescent material (e.g. phosphor).

In the fluorescent diffusion board according to the embodiment of the invention, a light source having a wavelength of a color different from a color produced by the fluorescent material may be transmitted from the lower surface of the second layer to the first layer and may thus be converted into a surface light source having a wavelength different from the wavelength of the light source on the first layer.

In a preferred embodiment of the invention, the fluorescent material may be a yellow-color-producing fluorescent material, and the light source may have a blue wavelength range, and the surface light source may have a white wavelength range.

In an embodiment of the invention, irregularities may be formed on either or both of the upper and lower surfaces of the first layer.

In a preferred embodiment of the invention, irregularities may be formed on either or both of the surface of the first layer that faces the second layer and the surface of the second layer that faces the first layer.

In an embodiment of the invention, the inorganic material may include one or two or more selected from among a glass fiber, a glass woven fabric, a glass nonwoven fabric, a glass bead, a glass powder, a glass flake, and a silica particle, etc.

In an embodiment of the invention, the second layer may further include one or two or more of inorganic material selected from among a glass fiber, a glass woven fabric, a glass nonwoven fabric, a glass bead, a glass powder, a glass flake, and a silica particle, etc.

In an embodiment of the invention, the fluorescent diffusion board may further comprise an adhesive layer between the first layer and the second layer.

In another embodiment of the present invention, a lighting system may comprise the fluorescent diffusion board for lighting as above and a light source device disposed under the second layer of the fluorescent diffusion board and configured such that the light source is irradiated.

According to the present invention, a fluorescent diffusion board for lighting enables a light source such as a point light source or the like to be more uniformly converted into a surface light source that is then diffused. Thus, a plurality of point light sources can be converted and diffused into a uniform surface light source. However, it has the effect that a decrease in luminance relative to the initially irradiated light source can be minimized.

### BRIEF DESCRIPTION OF THE DRAWING

FIG. 1 schematically shows a fluorescent diffusion board for lighting according to an embodiment of the present invention.

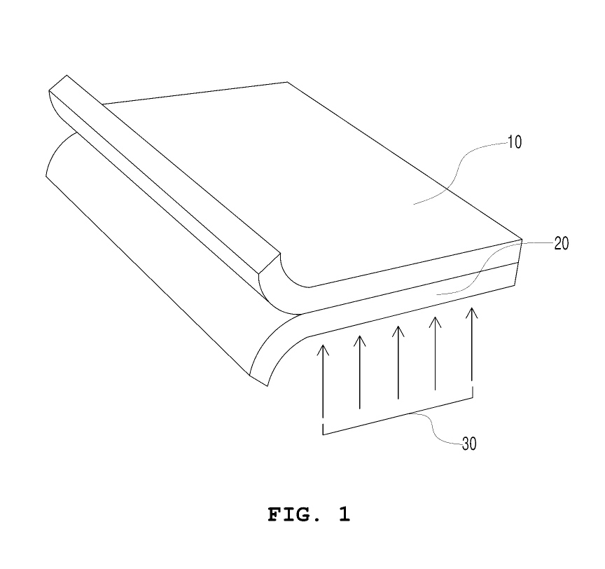

### DETAILED DESCRIPTION OF THE INVENTION

Hereinafter, a detailed description will be given of a fluorescent diffusion board for lighting according to the present invention with reference to the accompanying drawing.

The drawing of the present invention is exemplarily provided such that the spirit of the present invention may be sufficiently conveyed to those skilled in the art. Accordingly, the present invention is not limited to the drawing provided herein, but may be embodied in other forms, and such drawings may be exaggeratedly depicted to clearly express the spirit of the present invention.

Unless otherwise defined, all terms including technical and scientific terms used herein have the same meanings as commonly understood by those skilled in the art to which the present invention belongs. In the following description and accompanying drawing, it is to be noted that a detailed description of well-known function and constitution, when it would make the gist of the present disclosure unclear, will be omitted.

Unless otherwise mentioned, the “%” unit, when ambiguously used in the present invention, refers to “wt %”.

An embodiment of the present invention addresses a fluorescent diffusion board for lighting, comprising a first layer including an inorganic material and a polycarbonate resin, and a second layer laminated on one surface of the first layer and configured to include a polycarbonate resin and a fluorescent material. Accordingly, a light source having a wavelength of a color different from the color produced by the fluorescent material may be transmitted from the lower surface of the second layer to the first layer and may thus be converted into a surface light source having a wavelength different from the wavelength of the light source by means of the upper part of the first layer.

In a preferred embodiment of the present invention, the fluorescent material may be a yellow-color-producing fluorescent material, and the light source may have a blue wavelength range and the surface light source may have a white wavelength range. Thus, the light source having a blue wavelength range is transmitted through the second layer and the first layer and may be converted into a surface light source having a white wavelength range and diffused toward the upper part of the first layer.

Specifically, the first layer is attached to the second layer, whereby the light source that is incident through the second layer is converted into a uniform surface light source and is then diffused to the outside. Here, the first layer is manufactured containing an inorganic material and a polycarbonate resin, and the second layer is manufactured containing a yellow-color-producing fluorescent material and a polycarbonate resin, whereby the light source having a blue wavelength range may be more uniformly converted and diffused into a surface light source having a white wavelength range by passing through the first layer and the second layer.

The polycarbonate resin used for each of the first layer and the second layer is not particularly limited, and any weight average molecular weight thereof is permissible as long as the resin may be formed into a sheet through a general extrusion process. Specifically, the weight average molecular weight of the polycarbonate resin may fall in the range of 10,000 to 200,000. The polycarbonate resin may have a glass transition temperature ranging from 140 to 170° C.

As described above, when polycarbonate is used as a matrix material for the first layer and the second layer, the changed color of light emitted through the first layer without polarization of light is very soft and dim, whereby light may be uniformly emitted without a difference in light at individual positions, compared to when an acrylic resin or a polystyrene resin is used. For example, although not described in an exemplary embodiment, the results of sensory evaluation of 30 persons for the softness of light and the feeling of light at different positions, showed an improvement of 30% or more.

In an embodiment of the present invention, irregularities may be formed on one surface of the first layer or the second layer, including the upper surface, the lower surface or the upper and lower surfaces thereof.

In a preferred embodiment, the irregularities may be formed on either or both of the surface of the first layer that faces the second layer and the surface of the second layer that faces the first layer. As the irregularities are formed on either of the surface of the first layer that faces the second layer and the surface of the second layer that faces the first layer, the surface light source converted by passing the light source through the second layer and the first layer may have very uniform light emission characteristics, and the visual color thereof appears very dim and soft. The irregularities may be formed using any process for forming irregularities such as an embossing process, or may be formed by the inorganic material itself.

Specifically, when a light source having a specific wavelength such as a point light source, a line light source or the like is transmitted toward the first layer from the lower surface of the second layer and converted to get in on one surface of the first layer or the second layer having irregularities before the inside of the first layer, a decrease in luminance may be further minimized and the light diffusion capability and uniformity of the converted surface light source may be notably improved, compared to when irregularities are formed on the other surface (i.e. the upper surface) of the first layer.

More preferably, when the irregularities are formed on the surface of the first layer that faces the second layer and the surface of the second layer that faces the first layer, the visual effect in which the visible color is soft and dim may be further improved.

In an embodiment of the present invention, the irregularities may have a surface roughness of 0.01 to 50 μm within the scope of the present invention. Here, the term “surface roughness” indicates the extent of fine unevenness formed on the surface. When the above surface roughness is given within the above range, scattered reflection of the incident light source is induced, and it may thus be converted into a more uniform surface light source.

In an embodiment of the present invention, the inorganic material may include one or two or more of glass-based inorganic material selected from among a glass fiber, a glass woven fabric, a glass nonwoven fabric, a glass bead, a glass powder, a glass flake, and a silica particle. The average diameter of the inorganic material is not particularly limited so long as luminance is prevented from significantly decreasing, and may be, for example, 0.01 to 100 μm.

In the present invention, the reason why the glass-based inorganic material is adopted is that it is coupled with a polycarbonate matrix material and thus the luminance or brightness of light is not deteriorated and visual effects such as dimness, vividness and softness may be somewhat improved. In contrast, if an inorganic material other than the glass-based inorganic material having high transmittance is used, the visual effects of light may deteriorate, and luminance may be remarkably decreased.

As described above, the second layer includes a polycarbonate resin and a fluorescent material. In the present invention, the amount of the fluorescent material is not particularly limited so long as the incident light source may be converted into light having a required wavelength. For example, the fluorescent material is used in an amount of 0.001 to 20 parts by weight, and preferably 0.1 to 5 parts by weight, based on 100 parts by weight of the polycarbonate resin, but the present invention is not limited thereto.

The first layer and/or the second layer may further include a reinforcing agent, as necessary. The reinforcing agent may be the aforementioned inorganic material. If so, the luminance or brightness of light is not decreased, and visual effects such as freshness and softness may be further improved. In the visual effects based on sensory evaluation, when both the first layer and the second layer include the inorganic material or reinforcing agent of the same glass particle type, brightness may be decreased somewhat, but the extent of improvement of a visual effect is high, within the scope of the present invention. The amount of the reinforcing agent used for the second layer is not particularly limited. For example, the amount of the reinforcing agent may be set to the range of 0.1 to 50 parts by weight, based on 100 parts by weight of the polycarbonate resin.

As the fluorescent material, any inorganic or organic fluorescent material may be used so long as it is able to convert a light source having a specific wavelength into a light source having a wavelength different from the specific wavelength. Examples of the fluorescent material may include a first fluorescent material, a second fluorescent material, a third fluorescent material, etc., which may produce various colors (wavelengths) such as yellow, red, green, blue, etc. Preferably, when the fluorescent material is a yellow-color-producing fluorescent material, it may be coupled with the first layer composition (inorganic material and polycarbonate) and the second layer composition (polycarbonate), whereby the incident light source having a blue wavelength range may be converted into a more uniform surface light source having a white wavelength range.

The yellow-color-producing fluorescent material may be permissible so long as the light source having a blue wavelength range may be converted into visible light having a white wavelength range, and examples thereof may include YAG-based phosphors such as (Y_{1-xy}GdₓCe_{y})₃Al₅O₁₂, (Y₁₋ₓCeₓ)₃Al₅O₁₂, (Y₁₋ₓCeₓ)₃(Al_{1-y}Ga_{y})₅O₁₂, and (Y_{1-x-y}GdₓCe_{y})₃(Al₁₋ₓGa_{z})₅O₁₂, silicate-based phosphors such as (Sr,Ca,Ba,Mg)₂SiO₄:Eu and K₂SiF₆:Mn, and nitride phosphors such as (Ca, Sr) Si₂N₂O₂:Eu.

In an embodiment of the present invention, the composition of the second layer is not limited within the scope of the present invention, and may further include one or two or more selected from among a polyester resin, an acrylic resin and a cellulose resin, as necessary. Specifically, the second layer may further include, but is not limited to, 1 to 40 parts by weight of the above resin based on 100 arts by weight of the polycarbonate resin. More specifically, based on 100 parts by weight of the polycarbonate resin, one or two or more selected from among 5 to 20 parts by weight of a polyester resin, 10 to 40 parts by weight of an acrylic resin and 5 to 30 parts by weight of a cellulose resin may be further included.

In an embodiment of the present invention, the fluorescent diffusion board of the invention may further include an adhesive layer between the first layer and the second layer. When the adhesive layer is formed between the first layer and the second layer in this way, the durability of the fluorescent diffusion board for lighting may be further increased. In a preferred embodiment, the adhesive layer may be formed of polyolefin, polyester or a polyurethane-polyester copolymer, having high transparency. Particularly useful is polyolefin. In an embodiment of the present invention, each of the first layer, the second layer and the adhesive layer may further include a typically useful additive, and the additive may be used in an amount of 0.01 to 5 parts by weight based on 100 parts by weight of the polycarbonate resin. The additive may include, but is not limited to, one or two or more selected from among an antioxidant, a coloring inhibitor, a UV absorbent, a light diffusion agent, a flame retardant, a release agent, a lubricant, an antistatic agent, and a dye-pigment. In a preferred embodiment, an additive for providing moistureproofness and waterproofness is used to increase durability and weatherability so as to minimize problems due to exposure to the outdoors.

In an embodiment of the present invention, the average thickness of the first layer and the second layer is not particularly limited, and it is preferred that the thickness of the second layer be 10% to 500% of the thickness of the first layer.

Specifically, the average thickness of the first layer may be 0.5 to 10 mm. In this case, the surface light source, which is transmitted through the second layer and the first layer, converted and diffused, may minimize a decrease in luminance relative to the light source before being incident on the second layer, and a more uniform surface light source may result.

The fluorescent diffusion board for lighting of the invention is an integrated fluorescent diffusion board formed by stacking the first layer and the second layer using a co-extrusion process, and may thus exhibit superior durability and weatherability. Also, a trimming process and a bonding process, which are performed in subsequent procedures, may be easily conducted, thus achieving a variety of required shapes and morphologies. The shape and morphology of the fluorescent diffusion board including patterns, letters, etc. may be variously designed and modified without limitation as needed.

In addition, a lighting system according to an embodiment of the present invention may comprise the aforementioned fluorescent diffusion board for lighting and a light source device disposed under the second layer of the fluorescent diffusion board and configured such that the light source is irradiated. Specifically, the light source device is disposed under the second layer of the fluorescent diffusion board, whereby the point light source having a blue wavelength range is sequentially transmitted through the second layer and the first layer and may then be converted into a surface light source.

The light source device may include one or more light-emitting elements such as LEDs. The light-emitting elements may be classified into bottom-type light-emitting elements and edge-type light-emitting elements depending on the position of the light source, and the light source may be disposed at various positions without particular limitation so long as it is located under the second layer. Furthermore, the lighting system may further include a power supply for supplying energy to the light source device.

The fluorescent diffusion board for lighting and the lighting system according to an embodiment of the present invention may be used in various fields in which lighting is required. For example, the fluorescent diffusion board of the invention may be used for vehicles, including interior lights, rear lights, headlight accessories, etc. and may also be applied to indoor/outdoor lighting, advertising boards, etc. Moreover, as the fluorescent diffusion board is provided in the form of an integrated board, it is not limited in length and width compared to conventional hard boards, and may be applied to large-sized boards and may be easily employed in fields requiring slimness.

In addition, the present invention addresses a method of manufacturing the fluorescent diffusion board for lighting, comprising the steps of a) manufacturing a fluorescent pellet by melt-extruding a mixture comprising a polycarbonate resin and a fluorescent material, b) manufacturing a second layer by forming and processing the fluorescent pellet, and c) stacking the second layer on one surface of the first layer.

Here, the processing may be performed without limitation using molding or extrusion.

In step a), the mixture may include a polycarbonate resin and a fluorescent material, and may further include one or two or more selected from among a reinforcing agent, an additive, and the like. Also, the mixture is melt-extruded and formed into individual sheets, which may then be stacked by means of an adhesive layer or through co-extrusion. In the case of co-extrusion, however, no irregularities may be formed.

In step b), the second layer may be obtained by forming and processing the fluorescent pellet obtained in step a) in the form of a sheet.

In step c), the yellow-color-producing fluorescent material layer in sheet form obtained in step b) may be placed on the first layer and may then be integrated therewith. The fluorescent diffusion board thus manufactured may exhibit superior durability and weatherability and high luminous efficiency, remarkably maximized light diffusion capability.

The method of manufacturing the fluorescent diffusion board for lighting according to an embodiment of the present invention may further comprise preparing the first layer before step c). The preparing the first layer may be performed in a manner in which a mixture comprising an inorganic material and a polycarbonate resin may be processed in the form of a sheet.

In an embodiment of the present invention, the method of manufacturing the fluorescent diffusion board for lighting may further comprise forming surface irregularities on one surface of the first layer between the preparing the first layer and step c). Specifically, the forming the surface irregularities may be carried out in a manner in which the surface irregularities are formed on one surface of the first layer using an embossing process, for example, through pressing using an embossing roller.

Although the preferred embodiments of the present disclosure have been disclosed for illustrative purposes, those skilled in the art will appreciate that various modifications, additions and substitutions are possible, without departing from the scope and spirit of the invention as disclosed in the accompanying claims.

What is claimed is:

1. A fluorescent diffusion board for lighting, comprising:
a first layer comprising an inorganic material and a polycarbonate resin; and
a second layer formed on one surface of the first layer and configured to include a polycarbonate resin and a fluorescent material,
wherein a light source having a wavelength of a color different from a color produced by the fluorescent material may be transmitted from the lower surface of the second layer to the first layer and may thus be converted into a surface light source having a wavelength different from the wavelength of the light source on the first layer.

2. The fluorescent diffusion board of claim 1, wherein the fluorescent material may be a yellow-color-producing fluorescent material, and the light source may have a blue wavelength range, and the surface light source may have a white wavelength range.

3. The fluorescent diffusion board of claim 1, wherein irregularities may be formed on either or both of the surface of the first layer that faces the second layer and the surface of the second layer that faces the first layer.

4. The fluorescent diffusion board of claim 1, wherein the inorganic material comprises at least one selected from among a glass fiber, a glass woven fabric, a glass nonwoven fabric, a glass bead, a glass powder, a glass flake, and a silica particle.

5. The fluorescent diffusion board of claim 1, wherein the second layer further comprises at least one inorganic material selected from among a glass fiber, a glass woven fabric, a glass nonwoven fabric, a glass bead, a glass powder, a glass flake, and a silica particle.

6. The fluorescent diffusion board of claim 1, further comprising an adhesive layer between the first layer and the second layer.

7. A lighting system, comprising:
the fluorescent diffusion board of claim 1; and
a light source device disposed under the second layer of the fluorescent diffusion board and configured such that the light source is irradiated.

8. A lighting system, comprising:
the fluorescent diffusion board of claim 2; and
a light source device disposed under the second layer of the fluorescent diffusion board and configured such that the light source is irradiated.

9. A lighting system, comprising:
the fluorescent diffusion board of claim 3; and
a light source device disposed under the second layer of the fluorescent diffusion board and configured such that the light source is irradiated.

10. A lighting system, comprising:
the fluorescent diffusion board of claim 4; and
a light source device disposed under the second layer of the fluorescent diffusion board and configured such that the light source is irradiated.

11. A lighting system, comprising:
the fluorescent diffusion board of claim 5; and
a light source device disposed under the second layer of the fluorescent diffusion board and configured such that the light source is irradiated.

12. A lighting system, comprising:
the fluorescent diffusion board of claim 6; and
a light source device disposed under the second layer of the fluorescent diffusion board and configured such that the light source is irradiated.
